(19) United States
(12) Patent Application Publication
(10) Pub. No.: US 2008/0188207 A1
(43) Pub. Date: Aug. 7, 2008

(54) Apparatus and Method for Providing Service in Mobile Communication System

(76) Inventor: Changkeun Lee, Seoul (KR)

Correspondence Address: SALTAMAR INNOVATIONS, 30 FERN LANE, SOUTH PORTLAND, ME, 04106, US

(21) Appl. No.: 11/720,195

(22) PCT Filed: Jul. 5, 2005
(86) PCT No.: PCT/KR05/02150

§ 371 Date: May 24, 2007

(30) Foreign Application Priority Data
Nov. 27, 2004 (KR) 10-2004-0098319
Jun. 1, 2005 (KR) 10-2005-0046544

(51) Int. Cl. H04M 3/42

(52) U.S. Cl. 455/414.1

(57) ABSTRACT

Apparatus and method for providing service in mobile communication system in which a subscriber presets his profile information and desired person's information in his mobile terminal which is portable and can support mobility so as to allow the exchange of association information by retrieving a person with who the subscriber wants to be associated using a short-distance communication method, whereby the desired person can be retrieved faster and more precisely and also association with the other sex or with a person with a similar taste can be progressed more efficiently.

### TECHNICAL FIELD

The present invention relates to a Apparatus and method for providing service in mobile communications system, and more particularly, a service providing method and apparatus in a mobile communication system capable of retrieving a person with who a user wants to be associated and of exchanging association information with each other by using a mobile terminal which is individually portable and supports mobility.

### BACKGROUND ART

In general, relation with the other sex or associations with a person of similar taste may be usually made directly through offline activities or through companies such as matrimonial agencies, or people who have similar tastes may be accidentally associated therewith to thus keep their company.

For the relation with the other sex or association with a person who has a similar taste on the offline activity, it is not easy for a desired person to obtain information required for connection therebetween such as personal profile information or degree of favor. In particular, for the relation with the other sex, it is very difficult for a person to meet a person who matches his point of view of desired person. Accordingly, it may take a long time to meet his desired person, which means it is so difficult for him to meet a person who is satisfied with his wish.

Recently, in order to solve problems in the relation with the other sex or the association with a person having a similar taste on the offline activity, a web community service or an internet chatting service through an Internet connection is actively used to exchange information about the other sex or people having the similar taste.

However, the relation with the other sex and the association with a person having the similar taste through the web community service or Internet chatting service can smoothly be progressed by an exchange of information required for the association with the desired person through an exchange of multimedia information by using a web-based service function. However, because of the web-based information exchange, such information can be exchanged only using a computer terminal to which an Internet can be connected. In addition, in order to obtain information about a person desired by a subscriber, it is inconvenient that required information must be retrieved after performing a connection to a web site through the Internet every time.

Furthermore, the association service through an Internet is anonymously provided, and accordingly possibility of occurrence of improper information exchange such as sexual assault, sexual relationship with a supported younger partner, or the like. Rules for the association or information exchanging methods are not stipulated, and accordingly it is difficult to find the other sex or a person with the similar taste in a short time.

### DISCLOSURE OF INVENTION

### Technical Problem

Therefore, in order to solve the above problem, an object of the Apparatus and method for providing service in mobile communication system capable of retrieving a person with who a user (subscriber) wants to be associated using his mobile terminal which is individually portable and supports mobility and of exchanging association information after proposing to his desired person.

### Technical Solution

To achieve the above object, there is provided a mobile communication system in accordance with a characteristic of the present invention comprising: at least one or more mobile terminals to store code data with respect to profile information and desired person's information according to a subscriber's selection, and to provide a propose request message including identification information according to a consistency degree between code data received via a short-distance communication network and the code data of the desired person'S information; and an association management server to transmit a propose message to a second mobile terminal based upon the identification information through a mobile communication network and to transmit a propose response message to a first mobile terminal based upon a received response message when receiving the propose request message including the identification information from the first mobile terminal while managing identification information of each mobile terminal.

Each mobile terminal of the mobile communication system according to the present invention can comprise: a first storing unit to store code data based upon classified condition data by a condition item of the profile information according to the subscriber's selection; a second storing unit to store code data based upon classified condition data by a condition item of the desired person's information according to the subscriber's selection; and an association management processing unit to request profile information when another mobile terminal is approached within a range of the short-distance communication network, and to transmit the propose request message to the association management server according to a consistency degree between the condition item of the profile information according to the received coded data and the condition item of the desired person's information stored in the second storing unit.

The mobile terminal of the mobile communication system according to the present invention may further comprise a Bluetooth processing unit to transmit the code data using Wireless-Fidelity (Wi-Fi) or Bluetooth communication method through the short-distance communication network, and to provide the received code data to the association management server.

The mobile communication system according to the present invention may further comprise a recommendation mobile terminal to add recommendation information according to a condition item with respect to profile information of each mobile terminal.

According to another characteristic of the present invention, a mobile communication system can comprise: at least one or more mobile terminals to store code data of profile information and desired person's information according to a subscriber's selection, and to transmit an association message to another mobile terminal through a short-distance communication network according to a consistency degree between code data received from a mobile terminal via the short-distance communication network and the code data of the desired person's information.

Each mobile terminal according to the present invention may comprise: a third storing unit to store code data based upon classified condition data by a condition item of the profile information according to the subscriber's selection; a fourth storing unit to store code data based upon classified condition data by a condition item of the desired person's information according to the subscriber's selection; a fifth storing unit to store at least one or more association messages including association information and input code data corresponding to each association message; and an association processing unit to request profile information when another mobile terminal is approached within a range of the short-distance communication network, to display each association message stored in the fifth storing unit according to a consistency degree between the condition item of the profile information according to the received code data and the condition item of the desired person's information stored in the second storing unit, and to transmit the input code data corresponding to the association message selected by the subscriber to the another mobile terminal.

The mobile communication system according to the present invention may further comprise a program providing server to provide through a wired or wireless network an association processing program in which each mobile terminal generates code data according to profile information and desired person's information, requests profile information from another mobile terminal approaching to the short-distance communication network, and transmits association message thereto according to a consistency degree between the received profile information and the desired person's information.

According to still another characteristic of the present invention, a service providing method in a mobile communication system can comprise: a step in which at least one or more mobile terminals store code data based upon profile information and desired person's information according to a subscriber's selection; a step in which a first mobile terminal requests profile information from a second mobile terminal which approaches toward a short-distance communication network; a step in which the first mobile terminal transmits a propose request message including identification information to an association management server according to a consistency degree between the code data received from the second mobile terminal through the short-distance communication network and code data of desired person's information; a step in which the association management server transmits a propose message to the second mobile terminal through a mobile communication system according to the identification information included in the propose request message; and a step in which the association management server transmits a propose response message to the first mobile terminal according to a message in response to the propose message.

The Apparatus and method for providing service in mobile communication system according to the present invention can further comprise: a step in which the association management server manages identification information of each mobile terminal; a step in which the association management server recognizes the second mobile terminal according to the identification information included in the propose request message to transmit thereto the propose message including propose information or callback Uniform Resource Locator (URL) information; a step in which the second mobile terminal displays the propose information included in the propose message; and a step in which the second mobile terminal transmits a response message including propose acceptance information or propose refusal information according to the subscriber's selection to the association management server using the callback URL information.

The Apparatus and method for providing service in mobile communication system according to the present invention can further comprise: a step in which when the propose acceptance information is included in the response message received from the second mobile terminal, the association management server transmits subscriber information of the first mobile terminal to the second mobile terminal to thus set text communication or voice communication between mobile terminals; and a step in which when the propose refusal information is included in the response message received from the second mobile terminal, the association management server transmits the propose response message including the propose refusal information to the first mobile terminal.

The Apparatus and method for providing service in mobile communication system according to the present invention can further comprise: a step in which when receiving the propose request message from the first mobile terminal, the association management server determines a consistency degree between the profile information of the first mobile terminal and the desired person's information of the second mobile terminal; and a step in which when it is determined the consistency degree is the same as that included in the propose request message, the association management server transmits the propose message to the second mobile terminal.

The Apparatus and method for providing service in mobile communication system according to the present invention can further comprise: a step of backuping recommendation information in the association management server when the recommendation information with respect to the profile information is added to a recommendation mobile terminal of each mobile terminal; and a step of simultaneously transmitting the code data for the profile information together with the recommendation information when there is a request of the profile information.

The Apparatus and method for providing service in mobile communication system according to another characteristic of the present invention can further comprise: a step in which at least one or more mobile terminals store code data for profile information and desired person's information according to the subscriber's selection; a step in which the first mobile terminal requests the profile information from the second mobile terminal which is connected to the short-distance communication network; and a step in which the first mobile terminal transmits an association message to the second mobile terminal according to a consistency degree between the code data of the received profile information and the code data of the desired person's information.

The Apparatus and method for providing service in mobile communication system according to the present invention can further comprise: a step in which each terminal stores the association message including at least one or more association information and input code data corresponding to each association message; and a step in which each terminal transmits the input code data corresponding to the association message selected by the subscriber through the short-distance communication network.

The Apparatus and method for providing service in mobile communication system according to the present invention can further comprise: a step of storing condition information set by the subscriber; and a step of determining whether the consistency degree between the code data of the received profile information and the code data of the desired person's information satisfies the condition information; and a step of when it is determined that the condition information is satisfied therewith, determining a consistency degree of each code data.

The Apparatus and method for providing service in mobile communication system according to the present invention can further comprise: a step in which each mobile terminal requests an association managing program from the program providing server; a step in which each terminal receives the association managing program from the program providing server via a wired or wireless network; and a step in which each mobile terminal installs the association managing program and generates code data with respect to the profile information or desired person's information according to the subscriber's selection.

### Advantageous Effects

As mentioned above, after setting information related to a desired person with who a subscriber himself desires to be associated in his mobile terminal which is portable and can support mobility, association information is exchanged with a mobile terminal of another subscriber approached within a short-distance communication network according to the another subscriber's profile information and his desired person's information. Accordingly, the subscriber can communicate with another party for an association by frequently moving desired regions and also can retrieve a person who he wants to be associated faster and more precisely.

### BRIEF DESCRIPTION OF THE DRAWINGS

FIG. 1 is a block diagram illustrating a service providing system in accordance with a first embodiment of the present invention;

FIG. 2 is an inner block diagram illustrating a mobile terminal in accordance with the present invention;

FIG. 3 is a block diagram illustrating a construction of the mobile terminal of FIG. 1;

FIG. 4 is a view illustrating a structure of storing information of a first database according to the present invention;

FIG. 5 is a view illustrating a structure of storing messages of a second database according to the present invention;

FIG. 6 is a block diagram illustrating another construction of the mobile terminal of FIG. 1;

FIG. 7 is a flow chart illustrating sequential steps of a service providing method in accordance with a first embodiment of the present invention;

FIG. 8 is a block diagram illustrating a service providing method using recommendation information in accordance with a first embodiment of the present invention;

FIG. 9 is a block diagram illustrating profile information flow of the service providing method using the recommendation information;

FIG. 10 is a block diagram illustrating a service providing system in accordance with a second embodiment of the present invention;

FIG. 11 is a network block diagram illustrating the mobile communication system in accordance with the second embodiment of the present invention;

FIG. 12 is a block diagram illustrating a structure of a fourth database according to the present invention;

FIG. 13 is a flow chart illustrating sequential steps of a service providing method in accordance with a second embodiment of the present invention; and

FIG. 14 is a block diagram illustrating a service providing method using recommendation information in accordance with a second embodiment of the present invention.

### EXPLANATION FOR THE MAJOR REFERENCE NUMERALS

10: key input unit 12: display unit

14: program memory 16: data memory

18: microprocessor 20: digital signal processing unit

22: baseband converting unit 24: speaker

26: microphone 28: RF signal processing unit

*30: Bluetooth module 40: association processing program

42: first database 44: second database

340: association management server

100, 120, HP1, HP2: mobile terminal

### BEST MODE FOR CARRYING OUT THE INVENTION

Hereinafter, a service providing method and apparatus in a mobile communication system according to the present invention will now be explained in detail with reference to the attached drawings.

FIG. 1 is a block diagram illustrating a service providing program in accordance with a first embodiment of the present invention.

As illustrated in FIG. 1, a service providing system according to the present invention may include a program providing server to provide association processing program information, and a plurality of mobile terminals to download the association processing program information to exchange information required for the association.

Mobile terminals indicate terminals by which voice communication and short messaging communication can be executed through a mobile communication network and data communication can be executed through a wireless Internet. The mobile terminals exchange information for association with other mobile terminals located adjacent thereto using a Bluetooth communication method.

Such mobile terminals may include mobile phones or Personal Digital Assistants (PDAs) capable of performing wireless Internet data communications, notebook computers having a communication module therein and of which mobility is secured, palm computers, and various terminals capable of exchanging information with other terminals using a short-distance communication method.

The program providing server provides each mobile terminal with association processing program information according to request from each mobile terminal through a mobile communication network or a wireless Internet network, the association processing program information allowing an exchanging of association information which is required for association with another mobile terminal.

Each mobile terminal downloads service program information from the program providing server through the mobile communication network or the wireless Internet network for installation. The subscriber of each mobile terminal sets his profile information in his mobile terminal using the service program according to items and sets desired person's information according to items.

Here, the association processing program may be downloaded from the program providing server through the wireless Internet network or mobile communication network, or be mounted in the corresponding mobile terminal at the beginning of manufacturing the association processing program, or be downloaded using other communication methods (e.g., using USB communication, infrared communication, or the like).

Each mobile terminal installs the association processing program. Then, when another mobile terminal is approached within a region in which information can be exchanged depending on a Bluetooth communication method in a state that the subscriber has set his profile information and desired person's information in his mobile terminal, each mobile terminal exchanges profile information and propose information set by the subscriber with the approached another mobile terminal.

For instance, when a second mobile terminal is approached within the region capable of being communicated using the Bluetooth communication method, a first mobile terminal transmits code data based upon the subscriber's profile information to the second mobile terminal.

The second mobile terminal then recognizes the profile information related to the subscriber of the first mobile terminal according to the code data received from the first mobile terminal. The second mobile terminal checks a consistency degree between the profile information of the first mobile terminal and the desired persons's information set by the subscriber of the second mobile terminal, which is then converted into numerical marks (points) based upon the consistency degree for displaying.

When the marks based upon the consistency degree between the profile information of the first mobile terminal and the desired person's information of the subscriber of the second mobile terminal are greater than a certain number, the subscriber of the second mobile terminal transmits propose information to the first mobile terminal.

That is, the second mobile terminal transmits the propose information to the first mobile terminal according to the subscriber's selection using the Bluetooth communication method, and the first mobile terminal displays the received propose information to then transmit personal information to the second mobile terminal according to the subscriber's selection.

Here, the personal information transmitted from the first mobile terminal to the second mobile terminal may indicate identification information of the first mobile terminal such as phone number thereof or subscriber information thereof.

That is, each mobile terminal may exchange personal information with each other, and thus the subscriber thereof can receive another party's personal information.

The second mobile terminal may not display the personal information received from the first mobile terminal in order to prevent interference in other's personal concerns but preferably store it temporarily, so that the personal information can be used in the process of keeping company.

Upon receiving the personal information such as the phone number from the first mobile terminal, the second mobile terminal sets a voice communication with the first mobile terminal according to the subscriber's selection, or transmits a short message so that the subscriber of each mobile terminal can perform the information exchange for his association.

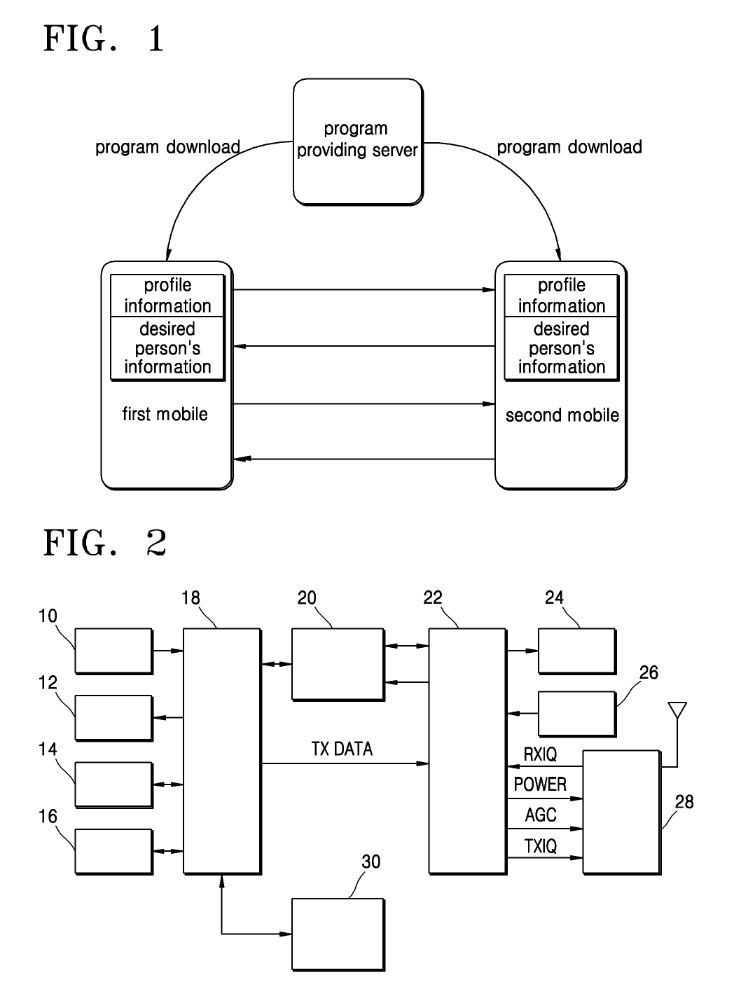

FIG. 2 is a block diagram illustrating a mobile terminal according to the present invention.

As illustrated in FIG. 2, a mobile terminal according to the present invention may include a key input unit 10, a display unit 12, a program memory 14, a data memory 16, a microprocessor 18, a Digital Signal Processing unit (DSP) 20, a baseband converting unit 22, a speaker 24, a microphone 26, a Radio Frequency (RF) signal processing unit 28 and a Bluetooth module 30.

The key input unit 10 may include numerical buttons (not shown) to input phone number information by a subscriber, character buttons (not shown) to input text information and a selection button (not shown) to select a menu. The key input unit 10 provides a key signal depending on a button selected by the subscriber.

That is, the subscriber sets profile information, desired person's information and the like by the key input unit 10, transmits propose information to another party's mobile terminal according to a consistency degree with the another party's profile information and his desired person's information, and keeps company therewith by voice communication or short message exchange with the another party's mobile terminal.

The display unit 12 displays status information of each mobile terminal such as power state thereof, wave received state, information related to data or time, or the like, and also displays display information for setting the profile information and desired person's information set by the subscriber and marks according to the consistency degree between the another party's profile information and the desired person's information related to the subscriber.

The display unit 12 displays association information according to a short message received from the another mobile terminal.

The program memory 14 stores information related to a software program for communication to perform a voice communication service and a short message service through a mobile communication network and information related to an association processing program for the association with another party.

The data memory 16 stores data based upon the profile information and the desired person's information set by the subscriber using the association processing program, and personal information and association information received from the another party's mobile terminal.

The Bluetooth module 30 transmits code data provided from the microprocessor 18 using a Bluetooth communication method to the Bluetooth module of another mobile terminal which is approached nearby, or provides the code data received from the another mobile terminal to the microprocessor 18.

Here, the Bluetooth module 30 transmits data at a maximum data transmission speed of 1 Mb/sec through an Industrial Scientific Medical (ISM) frequency band of 2.4 GHz, and uses a time-division duplex scheme for a full duplex transmission. The Bluetooth module 30 maintains a firm communication connection status by a short packet transmission and a fast frequency hopping.

The microprocessor 18 sets profile information and desired person's information according to a key signal received from the key input unit 10. When another mobile terminal is approached nearby, the microprocessor 18 provides code data based upon the profile information to the Bluetooth module 30 to transmit it to the another mobile terminal, and displays marks based upon a consistency degree between profile information according to code data received from the another mobile terminal and desired person's information.

The microprocessor 18 transmits personal information or association information according to the subscriber's selection to another mobile terminal through the Bluetooth module 30.

The microprocessor 18 also transmits a communication request message according to the subscriber's selection to another mobile terminal to set a voice communication capable of exchanging association information, or transmits a short message including the association information to the another mobile terminal.

The microprocessor 18 sets profile information and desired person's information according to a key signal inputted by the subscriber, and transmits profile information, personal information, propose information and association information to the another mobile terminal through the Bluetooth module 30. The microprocessor 18 also displays numerical marks according to a consistency degree between the profile information received from the another mobile terminal and the desired person's information and association information received therefrom.

The baseband converting unit 22 converts an analog signal received from a microphone 26 into a digital signal to transmit it to the microprocessor 18, and converts a digital signal received from the microprocessor 18 into an analog signal to transmit it to a speaker 24 or an RF signal processing unit 28. That is, the baseband converting unit 22 converts a signal received into a baseband signal and performs a digital-analog conversion and an analog-digital conversion.

The baseband converting unit 22 converts transmission message data TX DATA received from the microprocessor 18 into a transmission message signal TXIQ to thus transmit it to the RF signal processing unit 28, or converts a reception message signal RXIQ inputted from the corresponding RF signal processing unit 28 into reception message data RX DATA to thus transmit it to a digital signal converting unit 20.

The digital signal processing unit 20 performs an audio data processing function of encoding or decoding audio data SPEECH transceiving with the baseband converting unit 22, and performs an equalizing function of removing noise generated in a multiple path.

The RF signal processing unit 28 converts the transmission message signal into an RF signal to output it to an antenna, or converts the RF signal applied from the antenna into the reception message signal RXIQ to output it to the baseband converting unit 22.

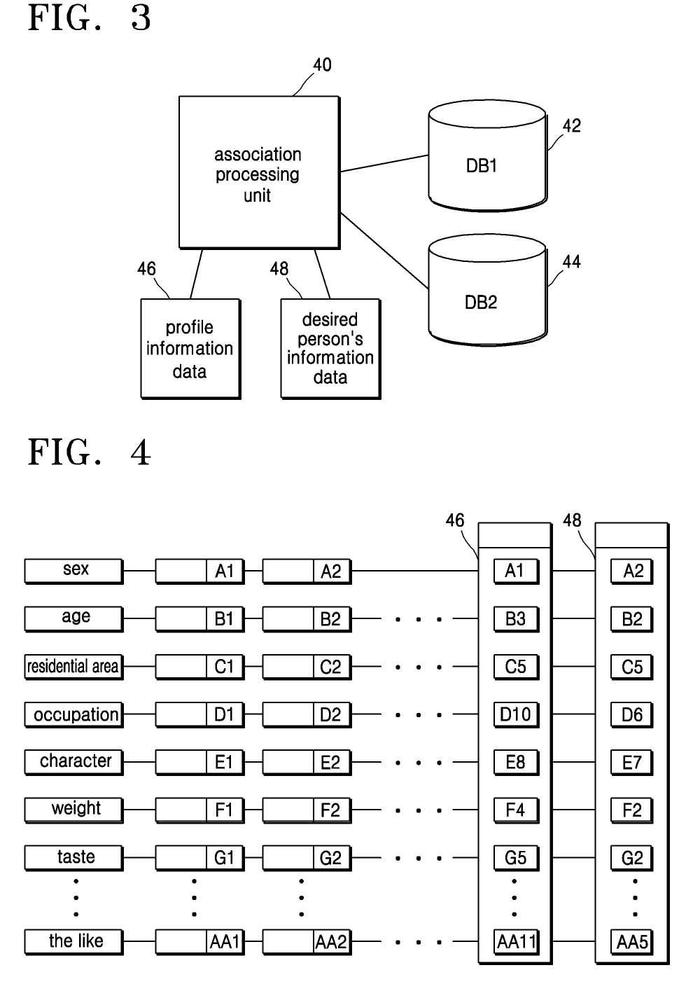

FIG. 3 is a block diagram illustrating a construction of the mobile terminal of FIG. 1.

As illustrated in FIG. 1, the mobile terminal according to the present invention may include an association processing program 40, a profile information data 46, a desired person's information data 48 and a plurality of databases 42 and 44.

A first database (condition information database) 42 stores a plurality of condition items and classified condition data corresponding to each condition item.

FIG. 4 is a view illustrating a structure of storing information of the first database according to the present invention.

As illustrated in FIG. 4, the first database 42 classifies data based upon each condition item (i.e., sex, age, residential area, occupation, character, weight, taste and the like), and stores a plurality of classified condition data with respect to each condition item (e.g., employee, doctor, teacher, lawyer or the like if the condition item is the occupation) and code data corresponding to each classified condition data (e.g., employee—D1, doctor—D2, teacher—D3, lawyer—D4, or the like if the condition item is the occupation).

The association processing program 40 sets each classified condition data according to each condition item of the first database 42 depending on a subscriber's key selection, and generates profile information data using the code data according to each classified condition data selected by the subscriber. That is, the association processing program 40 generates code data according to the subscriber's profile information.

The association processing program 40 displays each condition item or each classified condition data of the first database 42 to allow the subscriber to select classified condition data according to each condition item, and generates profile information data according to the classified condition data selected by the subscriber.

Each condition item and classified condition data of the first database 42 may be preferably set to have the same structure in each mobile terminal which exchanges association information with each other.

The association processing program 40 displays each condition item and each classified condition data of the first database 42 to allow the selection of a condition related to the person who the subscriber is concerned.

That is, the association processing program 40 displays information such as bet desired person according to the subscriber's selection and thereafter displays each condition item and each classified condition data of the first database 42. The association processing program 40 then generates a desired person's information data 48 using the code data corresponding to the classified condition data selected by the subscriber.

The second database (message information) 44 may store a plurality of association messages for exchanging association information with another party and a peculiar input code corresponding to each association message.

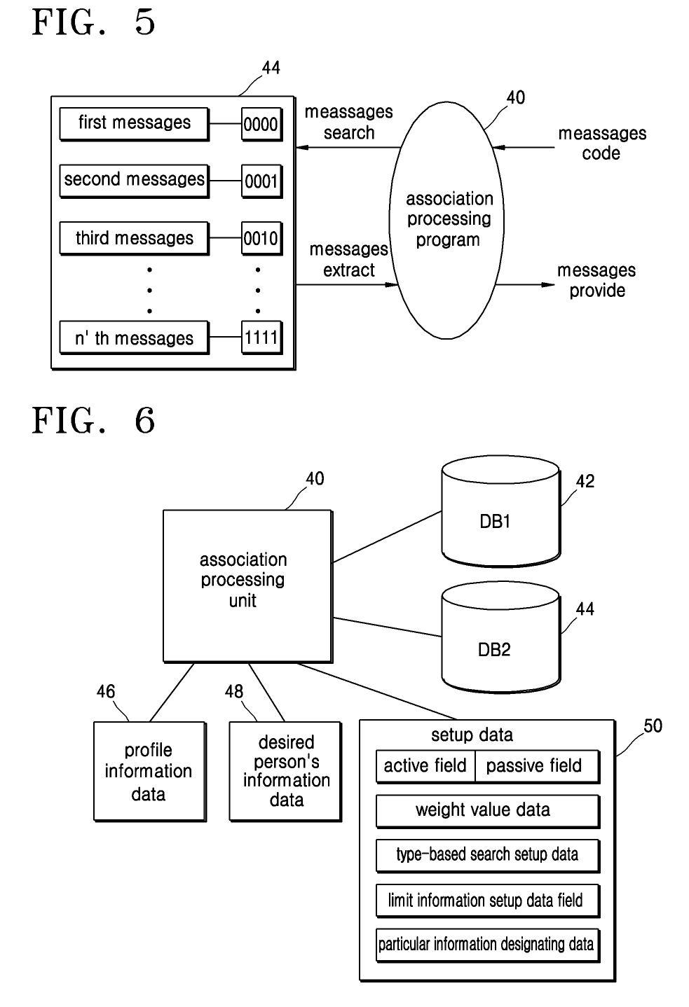

FIG. 5 is a view illustrating a message storing structure of a second database according to the present invention. As illustrated in FIG. 5, the second database 44 stores a plurality of association messages (i.e. the first through the n^{th} messages) containing association information and input codes (0000˜1111) corresponding to each association message.

The second database 44 may preferably be stored using the same structure in each mobile terminal which exchanges the association information therewith.

The association processing program 40 retrieves profile information corresponding to the received code data from the first database 42, and then displays marks according to a consistency degree between desired person's information according to the desired person's information data 48 and the retrieved profile information. The association processing program 40 displays each association message of the second database 44 and thereafter transmits an input code according to the association message selected by the subscriber.

The association processing program 40 retrieves an association message from the second database 44 according to the received input code to display association information based upon the association message.

That is, each mobile terminal only transmits the code data corresponding to the subscriber's profile information and the input code corresponding to the association message to another mobile terminal connecting to a short-distance network to enable a transmission of data having a small capacity through a wireless network, thereby transferring accurate information without error regardless of a communication environment. Each mobile terminal only transmits information standardized in each database 42 and 44 to thus prevent transferring of malicious contents and invasion of privacy.

FIG. 6 is a block diagram illustrating another construction of the mobile terminal of FIG. 1.

As illustrated in FIG. 6, the mobile terminal according to the present invention may include the association processing program 40, the profile information data 46, the desired person's information data 48, a setup data 50 and a plurality of databases 42 and 44.

The setup data 50 may include an active field, a passive field, a weight value data field, a type-based search setup data field, a limit information setup data field and a particular information designating data field.

That is, the mobile terminal can set the profile information data 46 and the desired person's information data 48, and generate the setup data 50 for setting an association function according to the subscriber's selection.

The association processing program 40 retrieves another mobile terminal approaching to the short-distance communication network according to the subscriber's selection to set whether to transmit the profile information actively or only to receive profile information from another mobile terminal using the active field and the passive field.

The association processing program 40 sets a weight value in a particular condition item among a plurality of condition items of the desired person's information data 48 according to the subscriber's selection using the weight value data field.

For example, in the state that the subscriber sets the weight value in an occupation item and an economic power item related to a desired person among the plurality of condition items. Upon calculating marks according to the consistency degree between another party's profile information and the corresponding desired person's information, if high marks are allocated to the weight value-set condition item according to the set weight value or the weight value-set condition item is satisfied, the association processing program 40 displays the satisfied condition item on the display unit 12 even if other condition items are not satisfied to thus notify that the another party can be associated with the subscriber.

The association processing program 40 can set desired type information by collecting information classified according to each type such as basic information (age, residential area, physical information and the like), intelligence information (academic background, major, marks of foreign language ability test and the like), sensitivity information (character, taste and the like), economic power information (occupation, annual salary, real estate holding, cash possessed and the like) through the type-based search setup data field, so as to enable a direct confirmation of the classified condition items actually selected rather than numerical marks. Also, the association processing program 40 displays the age, the residential area and the physical information related to the another party in detail through the display unit 12 when the subscriber selects the basic information in the type-based searching.

The association processing program 40 can set classified condition item of a condition item to be limited among a plurality of condition items set in the desired person's information data 48 using a limit information setup data field according to the subscriber's selection. For example, if the subscriber sets limits to the classified condition as younger than 24 and older than 40 in the age condition item or sets limits to the classified condition as more than 60 Kg in the weight condition item, when any of the another party's profile information received using the Bluetooth communication method is identical to the set classified condition, the association processing program 40 releases the connection automatically to terminate an association function.

Here, by limiting the age to be able to be associated with as the condition item which is intended to be limited using the limit information setup data field (e.g., limiting an association information communication with juvenile younger than 19), it is available to prevent an improper use in sexual relationship with a young partner associated by supporting the juvenile which is a social problem in recent times.

The association processing program 40 can set such that another party any of his profile information matches particular information which the subscriber desires can be retrieved according to the subscriber's selection using a particular information designating data field.

For example, when a condition item related to a RH− blood type in the condition items related to blood types is set as the particular information, the association processing program 40 retrieves a mobile terminal in which the RH− blood type among the condition items related to the blood types is set in the profile information received from the another party's mobile terminal located within a certain short-distance region in which a Bluetooth communication is available.

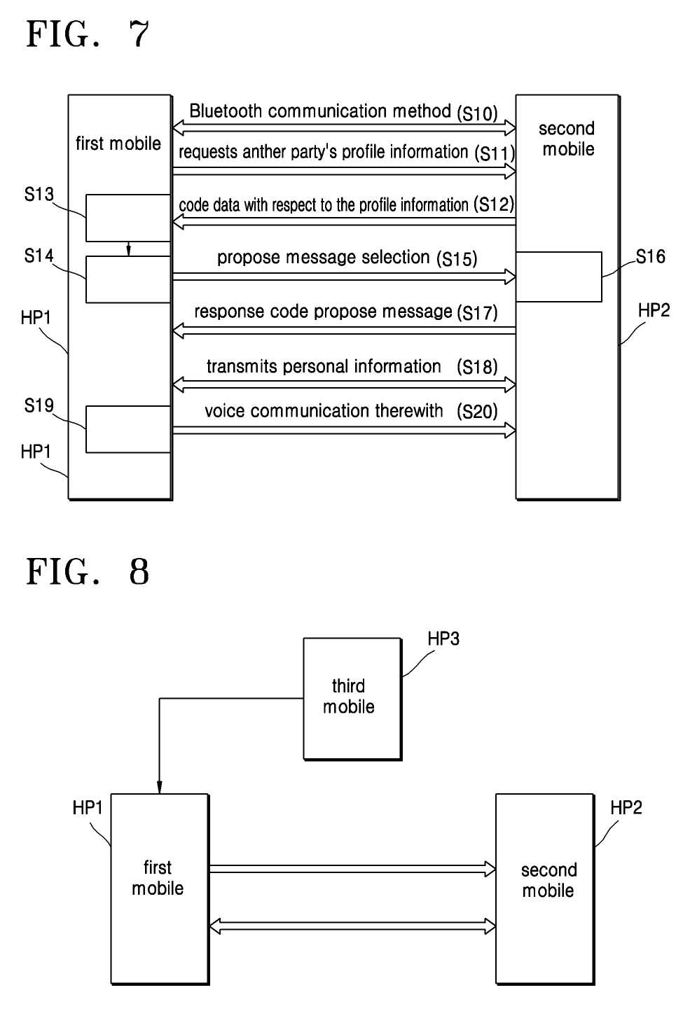

FIG. 7 is a flow chart illustrating sequential steps of a service providing method in accordance with a first embodiment of the present invention.

As illustrated in FIG. 7, first mobile terminal HP1 and second mobile terminal HP2 operate the association processing program 40 according to the subscriber's selection and set the profile information data 46 and the desired person's information data 48. When the second mobile terminal HP2 is approached within a region in which a short-distance communication is available according to a Bluetooth communication method, a sync (communication synchronization) for an intercommunication is set according to the Bluetooth communication method (S10).

Upon setting the sync, the first mobile terminal HP1 requests another party's profile information from the second mobile terminal HP2 (S11). The second mobile terminal HP2 then transmits code data with respect to the subscriber's profile information to the first mobile terminal HP1 (S12).

Here, the first mobile terminal HP1 must be limited to process the profile information by software according to the code data received from the second mobile terminal HP2, and does not have to inquire into contents of the profile information in a state in which the type-based search setup (refer to FIG. 6) is not done.

If condition items which are allowable to open contents included in the profile information received from the second mobile terminal HP2 (e.g., height, weight, taste, special ability and the like) have been set as open items, the first mobile terminal HP1 inquires into the open items among the entire profile information.

The first mobile terminal HP1 recognizes the profile information according to the code data received from the second mobile terminal HP2 and determines a consistency degree by comparing the profile information to desired person's information according each condition item (S13). The first mobile terminal HP1 then converts numerical marks according to the consistency degree to display the converted marks on the display unit 12 (S14).

Here, when the numerical marks are calculated as marks more than particular points (e.g., more than 80 points among full points of 120), the first mobile terminal HP1 displays a plurality of association messages stored in the second database 44, and transmits an input code corresponding to an association message representing an initial propose (e.g. a propose message such as You are my type. Would you like a cup of coffee with me?) to the second mobile terminal HP2 according to the subscriber's selection (S15).

On the other hand, when the marks according to the consistency degree between the profile information and the desired person's information are less than particular points, the first mobile terminal HP1 terminates a communication connection for the association with the second mobile terminal HP2 according to the subscriber's selection.

The second mobile terminal HP2 retrieves the association message (propose message) according to the input code received from the first mobile terminal HP1 from the message information database (e.g., the second database) 44 to thus display the retrieved message through the display unit 12 (S16).

The second mobile terminal HP2 displays the propose message. Upon accepting the subscriber's propose, the second mobile terminal HP2 transmits a response code (e.g., yes) in response to the propose message (S17).

When the subscriber of the second mobile terminal HP2 accepts the propose, the second mobile terminal HP2 transmits personal information (e.g. a phone number) to the first mobile terminal HP1. Upon receiving the response code, the first mobile terminal HP1 transmits its subscriber's personal information and profile information to the second mobile terminal HP2 (S18).

Here, the second mobile terminal HP2 requests the profile information from the first mobile terminal HP1. It is preferable that the second mobile terminal HP2 calculates numerical marks according to the consistency degree between the profile information of the first mobile terminal HP1 and its desired person's information for displaying to thus allow the subscriber to select his response with respect to the propose.

Upon receiving personal information from the second mobile terminal HP2, on the other hand, the first mobile terminal HP1 displays a message containing contents such as He accepts propose. Would you contact with him? to ask whether to perform the communication connection therewith (S19). The first mobile terminal HP1 then transmits a communication request message to the second mobile terminal HP2 according to the subscriber's selection to thus connect the voice communication therewith (S20).

The first mobile terminal HP1 can transmit a short message including text information to the second mobile terminal HP2 according to the subscriber's selection.

In addition, the second mobile terminal HP2 can transmit the communication request message or the short message according to the subscriber's selection.

FIG. 8 is a block diagram illustrating a service providing method using recommendation information in accordance with a first embodiment of the present invention.

As illustrated in FIG. 8, the service providing system may include first mobile terminal HP1 and second mobile terminal HP2 for performing communication related to association, and a third mobile terminal HP3 for recommending profile information of the subscriber of each mobile terminal to increase reliability of the profile information.

That is, a third recommender is introduced in order to increase reliability of the subscriber's profile information set by the association processing program 40, so as to provide recommendation information by including it in the profile information. Accordingly, for determining the response with respect to the propose, the recommendation information can be referred to.

The subscriber of the third mobile terminal HP3 recognizes profile information with respect to extroversive/introversive side, intellectual/sensitive side, economic power side and the like with respect to the subscriber of the first mobile terminal HP1, and provides profile recommendation information related to the recognized sides to the first mobile terminal HP1.

The third mobile terminal HP3 has a program mounted therein for performing a recommendation function with respect to subscribers of other mobile terminals. The subscriber of the third mobile terminal HP3 preferably obtains reliability and public confidence of the recommendation information by adapting socially influential men (e.g., politicians, persons in economic circles, journalists, entertainers, persons engaged in culture and art and the like).

When the second mobile terminal HP2 requests the profile information according to the Bluetooth communication method, the first mobile terminal HP1 transmits the profile information including profile recommendation information provided from the third mobile terminal HP3 to the second mobile terminal HP2.

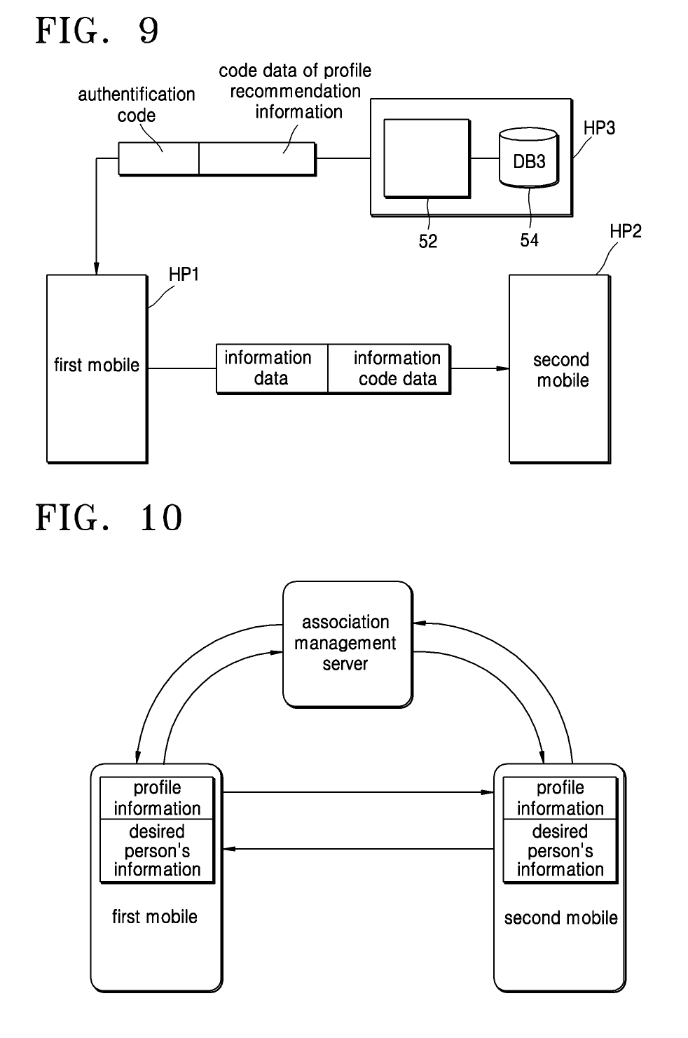

FIG. 9 is a block diagram illustrating a profile information flow in the service providing method using the recommendation information.

As illustrated in FIG. 9, the third mobile terminal HP3 may include a recommendation processing program 52 to provide the recommendation information with respect to the subscriber's profile information of another mobile terminal, and a third database (recommendation information) 54 to store various types of recommendation information for recommending physical, intellectual, sensitive and economic sides with respect to a person to be recommended.

The third database 54 stores recommendation information items with respect to each condition item set as the profile information of each mobile terminal HP1 and HP2 and each recommendation information.

Here, each recommendation information item of the third database 54 may preferably have the same code system as the classified condition of each condition item stored in the first database 42 of the mobile terminal.

The recommendation processing program 52 of the third mobile terminal HP3 provides an authentication code for an authentication process and code data of profile recommendation information to a mobile terminal (e.g., the first mobile terminal HP1) according to the subscriber's selection.

The association processing program 40 of the first mobile terminal HP1 performs the authentication process according to the authentication code provided from the third mobile terminal HP3 and adds the code data of the profile recommendation information additionally to his profile information data 46 and then stores it.

If the second mobile terminal HP2 requests profile information of the first mobile terminal HP1 according to the Bluetooth communication method, the association processing program 40 of the first mobile terminal HP1 transmits to the second mobile terminal HP2 a code data of his profile information together with the code data of the profile recommendation information provided from the third mobile terminal HP3.

The second mobile terminal HP2 compares the code data of the profile information received from the first mobile terminal HP1 to the code data of desired person's information to calculate numerical marks, and also extracts classified condition data with respect to the condition item corresponding to the code data of the profile recommendation information from the second database 42 to inquire into the recommendation information of the third person.

For example, if the recommendation information is a recommendation item such as very intellectual, the second mobile terminal HP2 can inquire into a message such as very intellectual as the classified condition of the condition item of the condition information database corresponding to the code data of the recommendation item.

In order to secure the transmitted profile information, on the other hand, each mobile terminal does not transmit the code data of the profile recommendation information in order to refer another party to the contents of the profile recommendation information in detail, but can transmit only information related to the number of persons to have been recommended.

That is, each terminal classifies information of the number of persons to have been recommended according to each type such as physical item, intellectual item, sensitive item, and economic item to thus only transmit the number of persons to have been recommended to the another party.

The mobile terminal also stores information related to the number of times for propose by counting the association messages (propose messages) received from another mobile terminal. If another mobile terminal requests the propose, the mobile terminal transmits information related to the number of times for propose, its profile information and recommendation information, so as to increase reliability for the profile information received by the person who has requested the association.

FIG. 10 is a block diagram illustrating a service providing system in accordance with a second embodiment of the present invention.

As illustrated in FIG. 10, the service providing system according to the present invention may include a plurality of mobile terminals which exchange information with one another using a Bluetooth communication method, and an association management server to transmit a propose message to another mobile terminal and to notify whether to accept a propose according to a received response message upon receiving a request for the propose from a mobile terminal.

Each mobile terminal downloads association program information from the association management server and downloads service program information through a mobile communication network or wireless Internet network for installation. The subscriber of each mobile terminal sets his profile information according to items in his mobile terminal using the service program, and sets desired person's information according to items.

Here, the association processing program may be downloaded from a program providing server through a wireless Internet network or a mobile communication network, or be mounted in the corresponding mobile terminal at the initial fabrication thereof, or be downloaded using other communication methods (e.g., USB communication, infrared communication, or the like).

When another mobile terminal is approached to a region in which a short-distance communication is available using a Bluetooth communication method, each mobile terminal transmits code data of its profile information and identification information such as an electronic serial number (ESN), and displays numerical marks according to a consistency degree between the profile information received from the another mobile terminal and desired person's information set by the subscriber.

Here, the identification information transmitted from each mobile terminal to the another mobile terminal may indicate information related to the ESN or information related to a short-distance communication module ID which is assigned peculiarly to a short-distance communication module such as a Bluetooth module.

When the marks according to the consistency degree between the profile information of the second mobile terminal and its desired person's information is greater than particular points, the subscriber of the first mobile terminal transmits propose information to the second mobile terminal to thereafter exchange association information with each other according to a received response message.

When the second mobile terminal goes beyond the region in which the short-distance communication is available, namely, when it is impossible to exchange association information with each other using the Bluetooth communication method, on the other side, the subscriber of the first mobile terminal accesses the association management server through a mobile communication network to transmit the propose request message thereto.

Here, the first mobile terminal may include information related to the ESN of the second mobile terminal or information related to the short-distance communication module ID in the propose request message according to the subscriber's selection.

The association management server stores the profile information of each mobile terminal subscribed to the association information service and desired person's information thereof. Upon receiving the propose request message from the first mobile terminal, the association management server transmits a propose message to the second mobile terminal.

The association management server transmits a propose response message to the first mobile terminal according to a response message received from the second mobile terminal to thus set a communication for exchanging association information between the first and second mobile terminals according to the determination whether to accept the propose of the second mobile terminal.

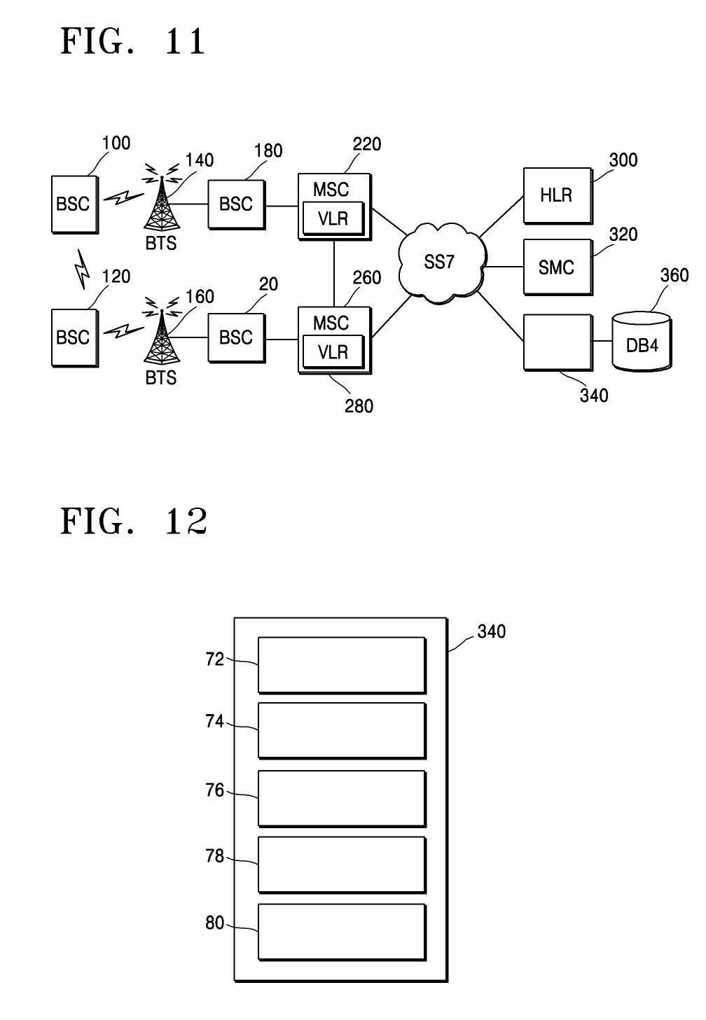

FIG. 11 is a network block diagram illustrating a mobile communication system in accordance with a second embodiment of the present invention.

As illustrated in FIG. 11, the mobile communication system according to the present invention may include a plurality of mobile terminals 100 and 120, base transceiver stations (BTSs) 140 and 160, base station controllers (BSCs) 180 and 200, mobile switching centers (MSCs) 220 and 260, visitor location registers (VLRs) 240 and 280, a home location register (HLR) 300, a short message center (SMC) 32, an association information management server 340, and a fourth database (association information management) 360.

Each mobile terminal 100 and 120 has a communication module such as a Bluetooth module for a short-distance communication and an association processing program to thus store profile information and desired person's information set by the subscriber. When another mobile terminal is approached within a particular radius in which the short-distance communication is available, each mobile terminal 100 and 120 exchanges profile information with each other to calculate marks based upon a consistency degree between the desired person's information and profile information for displaying thereof.

Each mobile terminal 100 and 120 may exchange messages with another mobile terminal according to the subscriber's selection, or set a voice communication therewith.

Meanwhile, the first mobile terminal 100 transmits a propose request message to the association management server 340 according to the subscriber's selection when the second mobile terminal 120 goes beyond the short-distance communication radius. The association management server 340 transmits a propose message to the second mobile terminal 120 upon receiving the propose request message from the first mobile terminal 100.

The association management server 340 transmits to the first mobile terminal 100 a propose response message including propose acceptance information or propose refusal information according to the response message received from the second mobile terminal 120.

That is, when a distance between the first mobile terminal 100 and the second mobile terminal 120 is longer than the short-distance communication radius, namely, when each mobile terminal 100 and 120 can not exchange the association information with each other using the Bluetooth communication method, the association management server 340 allows the exchange of the propose information between the mobile terminals 100 and 120 through the mobile communication network.

The base transceiver stations 140 and 160 are network terminating sets which are directly connected to the subscriber's mobile terminal, which perform a baseband signal processing, a wired or wireless conversion and transceiving of wireless signal. The base transceiver stations 140 and 160 transmit/receive a voice communication signal, a voice notification message or a data signal to/from each mobile terminal 100 and 120 according to an RF wireless signal processing method.

The base station controllers 180 and 200 are located between each base transceiver station 140 and 160 and each mobile switching center 220 and 260 to serve management and control of each base transceiver station 140 and 160. The base station controllers 180 and 200 process functions such as allocation/release of wireless channel with respect to each mobile terminal 100 and 120, control of transmission and output of the mobile terminals 100 and 120 and the base transceiver stations 140 and 160, determination of handoff between cells, and operation and maintenance of the base transceiver stations 140 and 160.

The mobile switching center 220 and 260 perform a function of processing received/originated call of mobile terminals, and location registering procedure and a handoff procedure of the mobile terminals 100 and 120 using each visitor location register 240 and 280 or the home location register 300, and provide a standby service during communication for a third party's call origination while the voice communication between the receiver and a certain originator is ongoing.

The visitor location registers 240 and 280 respectively register and manage subscriber information and location information with respect to the corresponding mobile terminals 100 and 120 which are located at a region managed by the mobile switching centers 220 and 260.

The home location register 300 stores subscriber information and location information with respect to the entire terminal subscribers registered in the mobile communication service, and is connected to the mobile switching centers 220 and 260 via an SS7 network to process a subscriber's location registration and a function of tracking subscribers.

The short message center 320 is connected to each mobile switching center 220 and 260 via the SS7 network to transmit a short message or a multimedia message including association information and propose information and a video message to each mobile terminal 100 and 120 according to a short message request of the association management server 340.

The association management server 340 stores profile information and desired person's information for the subscribers of each mobile terminal 100 and 120 having subscribed to the association information service. Upon receiving a propose request message from the mobile terminals 100 and 120, the association management server 340 transmits a propose message to the mobile terminals 100 and 120, and transmits thereto a propose response message including propose acceptance information or propose refusal information according to response messages received from the mobile terminals 100 and 120.

Here, each mobile terminal 100 and 120 can transmit the propose request message or the response message to the association management server 340 via the corresponding base transceiver stations 140 and 160, the corresponding base station controllers 180 and 200 and the corresponding mobile switching centers 220 and 260.

The association management server 340 can transmit the propose message or the propose response message in a short message form to each mobile terminal 100 and 120 via the short message center (SMC) 320.

The association management server 340 may set a voice communication call between mobile terminals or exchange short messages including the association information if the response message received after transmitting the propose message to the mobile terminals includes the propose acceptance information.

The association management server 340 can also receive profile information and desired person's information of each subscriber from each mobile terminal to store them in the fourth database 360.

The fourth database 360 stores the profile information and desired person's information related to the subscriber of each mobile terminal having subscribed to the association information service.

Each mobile terminal, as illustrated in FIG. 3, includes the association processing program 40, the profile information data 46, the desired person's information data 48 and a plurality of databases 42 and 44. The first database 42, as illustrated in FIG. 4, classifies data based upon each condition item (i.e., sex, age, residential area, occupation, character, weight, taste and the like), and stores a plurality of classified condition data with respect to each condition item (e.g., employee, doctor, teacher, lawyer or the like if the condition item is the occupation) and code data corresponding to each classified condition data (e.g., employee—Dl, doctor—D2, teacher—D3, lawyer—D4, or the like if the condition item is the occupation).

The association processing program 40 sets each classified condition data according to each condition item of the first database 42 according to the subscriber's key selection, and generates profile information data using code data according to each classified condition data selected by the subscriber. That is, the association processing program 40 generates the code data according to the subscriber's profile information.

The association processing program 40 can also display each condition item and each classified condition data of the first database 42 to allow the subscriber to select the classified condition data according to each condition item. The association processing program 40 generates profile information data according to the classified condition data selected by the subscriber.

Each condition item and classified condition data of the first database 42 may preferably be set using the same structure in each mobile terminal for exchanging association information therewith.

The association processing program 40 can display each condition item and classified condition data of the first database 42 to allow the subscriber to select another party's condition that the subscriber desires.

That is, the association processing program 40 displays information such as Set desired person according to the subscriber's selection and thereafter displays each condition item and classified condition data of the first database 42. Then, the association processing program 40 generates the desired person's information data 48 using the code data corresponding to the classified condition data selected by the subscriber.

The second database (message information) 44 may store a plurality of association messages for exchanging association information with another party and peculiar input codes corresponding to each association message.

FIG. 5 illustrates the message storing structure according to the present invention. As illustrated in FIG. 5, the second database 44 stores a plurality of association messages (the first through n^{th} messages) and input codes (0000˜1111) corresponding to each association message.

The second database 44 may be preferably stored using the same structure in each mobile terminal which exchanges association information with each other.

The association processing program 40 retrieves profile information corresponding to the received code data from the first database 42, and displays marks based upon a consistency degree between the desired person's information according to the desired person's information data 48 and the retrieved profile information. The association processing program 40 then displays each association message of the second database 44 and thereafter transmits the input code based upon the association message selected by the subscriber.

The association processing program 40 retrieves the association message according to the received input code from the second database 44 to display association information related to the association message.

The association management server 340 receives each subscriber's profile information and desired person's information from each mobile terminal to store them in the fourth database 360.

FIG. 12 illustrates a structure of the fourth database according to the present invention.

As illustrated in FIG. 12, the association management server 340 may include a subscriber information storing unit 72 to store subscriber information of each mobile terminal, a subscriber profile information storing unit 74 to store code data of profile information set in each mobile terminal by a subscriber, a subscriber desired person's information storing unit 76 to store code data of desired person's information set in each mobile terminal by the subscriber, a subscriber propose intention information storing unit 78 to store an ESN and consistency index of another mobile terminal according to a propose request message received from each mobile terminal and propose acceptance information or propose refusal information, and a propose message information storing unit 80 to store a plurality of propose messages for exchanging association information between a subscriber transmitting the propose request message and a subscriber receiving the propose message.

The subscriber information storing unit 72 can store subscriber information, namely, information such as terminal ESN, sex, age, name and the like, by obtaining it from the home location register 300 targeting subscribers having subscribed in an association information service, and can compose basic profile information based upon subscriber information obtained from the home location register 300 when profile information is set in each mobile terminal.

The subscriber profile information storing unit 74 and the subscriber desired person's information storing unit 76 store subscribers profile information and desired person's information received from each mobile terminal 100 and 120. When the subscriber of each mobile terminal 100 and 120 changes his profile information and desired person's information, the subscriber profile information storing unit 74 and the subscriber desired person's information storing unit 76 also change each subscriber's profile information and desired person's information.

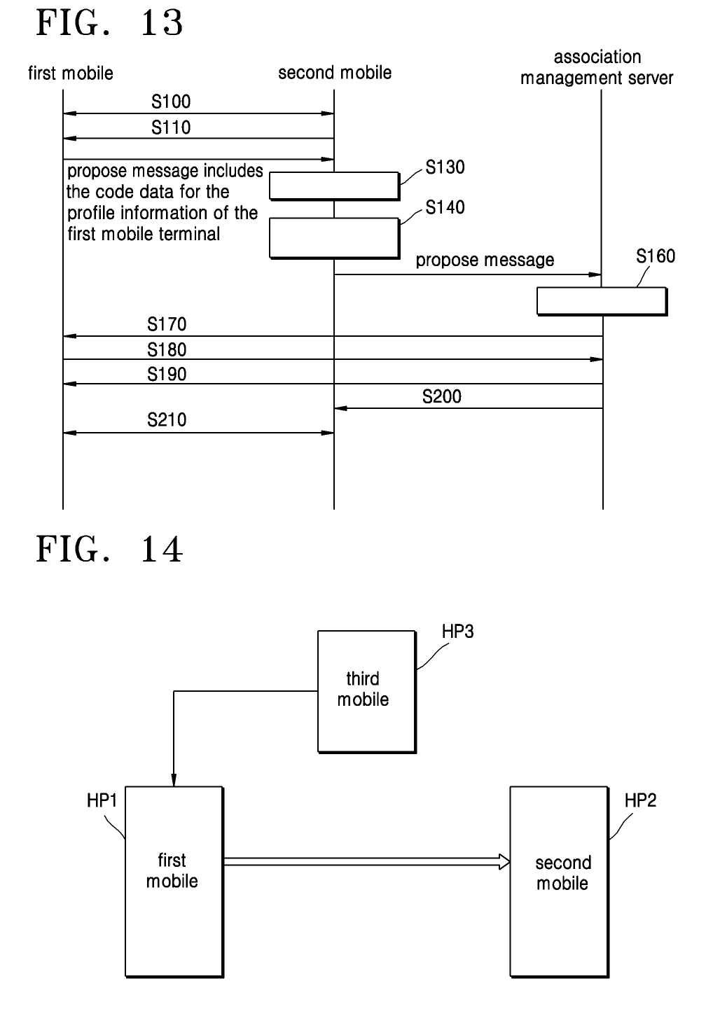

FIG. 13 is a flow chart illustrating sequential steps of a service providing method in accordance with a second embodiment of the present invention.

As illustrated in FIG. 13, each mobile terminal 100 and 120 sets a profile information data 68 and a desired person's information data 70 via an association processing program 62. When another mobile terminal is approached within a radius in which a short-distance communication is available, each mobile terminal 100 and 120 performs a sync setup process for an intercommunication therebetween by a Bluetooth module 60 (S100).

The first mobile terminal 100 requests profile information from the second mobile terminal 120 (S110). The second mobile terminal 120 transmits its ESN or Bluetooth module ID and code data related to the profile information to the first mobile terminal 100 (S120).

The first mobile terminal 100 then compares the code data of the profile information received from the second mobile terminal 120 with code data according to each condition item of the corresponding desired person's information and calculates a consistency degree therebetween. Thereafter, the first mobile terminal 100 converts numerical marks according to the consistency degree for displaying thereof (S130).

Here, if it is difficult to exchange association information with the second mobile terminal 120, the subscriber of the first mobile terminal 100 stores the ESN of the second mobile terminal 120 or the Bluetooth module ID thereof, consistency index and code data of the profile information in the data memory 46 (S140).

The first mobile terminal 100 transmits to the association management server 340 a propose request message including its terminal ESN or Bluetooth module ID and a consistency index and the terminal ESN of the second mobile terminal 120 or Bluetooth module ID information thereof according to the subscriber's selection (S150).

The association management server 340 refers to the fourth database 360 to recognize the subscriber of the second mobile terminal 120 using the terminal ESN or Bluetooth module ID of the second mobile terminal 120 received from the first mobile terminal 100. The association management server 340 compares profile information of the second mobile terminal 120 extracted from the subscriber profile information storing unit 74 with desired person's information of the first mobile terminal 100 extracted from the subscriber desired person's information storing unit 76 to thus confirm whether the consistency index received from the first mobile terminal 100 has been correctly calculated (S160).

The association management server 340 extracts the corresponding propose message (e.g., There is a remote propose from XXX. Do you accept it?) from the propose message storing unit 80 of the fourth database 360, and transmits the extracted propose message to the second mobile terminal 120 via the short message center 320.

Here, the propose message includes the code data for the profile information of the first mobile terminal 100 and callback URL information to thus allow the subscriber of the second mobile terminal 120 to confirm the profile information of the first mobile terminal 100 and to allow the subscriber to transmit a response message.

Upon receiving the propose message in the short message form, the second mobile terminal 120 recognizes the consistency index between the code data for the profile information of the first mobile terminal 100 and the code data of the desired person's information to thereafter display the propose message.

The subscriber of the second mobile terminal 120 confirms contents included in the propose message and then transmits to the association management server 340 a response message including propose acceptance information or propose refusal information via the callback URL (S180).

Upon receiving the response message including the propose acceptance information from the second mobile terminal 120, the association management server 340 transmits personal information (e.g., name or phone number) of the first mobile terminal 100 to the second mobile terminal 120 (S190). The association management server 340 notifies the first mobile terminal 100 of the result of the propose and transmits the personal information (e.g., name or phone number) related to the subscriber of the second mobile terminal 120 (S200).

The first and second mobile terminals 100 and 120 exchange association information with each other using a voice communication or text message or wireless Internet chatting service according to the another party's personal information received from the association management server 340, respectively (S210).

It has been explained that the association management server 340 indirectly transmits the personal information of opposite sides to the first and second mobile terminals 100 and 120 which have accepted the propose each other. However, the association management server 340 may be interworked with a separate chatting server (not shown) to relay text chatting between the first and second mobile terminals 100 and 120 or to relay the exchange of short messages therewith.

Upon receiving the response message including the propose refusal information from the second mobile terminal 120, the association management server 340 transmits the propose refusal information to the first mobile terminal 100 for notification thereto.

It has been explained that the association information is exchanged according to the response message that the association management server 340 has received after transmitting the propose message to the second mobile terminal 120. However, it is also possible that after transmitting the propose message, the association information is exchanged between the first and second mobile terminals 100 and 120 through a simple wireless Internet chatting between the first and second mobile terminals 100 and 120 for a certain time duration, and thereafter the response message is received from the second mobile terminal 120, thereby enabling the performing of the more fair proposing process.

FIG. 14 is a block diagram illustrating a service providing method using recommendation information in accordance with a second embodiment of the present invention.

As illustrated in FIG. 14, the first mobile terminal can receive profile recommendation information related to extroversive/introversive side, intellectual/sensitive side or economic side with respect to the subscriber of the first mobile terminal 100 from the subscriber of the third mobile terminal.

If another mobile terminal requests profile information, the first mobile terminal can simultaneously provide the profile recommendation information received from the third mobile terminal together with its profile information to the another mobile terminal.

Upon receiving the profile recommendation information from the third mobile terminal, the first mobile terminal additionally backups the profile recommendation information in the association management server 340. Accordingly, even if any situation such as loss or replacement of a mobile terminal occurs, the profile recommendation information can be re-provided from the association management server 340 without being lost.

1. A mobile communication system comprising:
at least one or more mobile terminals to store code data based upon profile information and desired person's information according to a subscriber's selection, and to provide a propose request message including identification information according to a consistency degree between code data received through a short-distance communication network and the code data of the desired person's information; and
an association management server to transmit a propose message to a second mobile terminal according to the identification information through a mobile communication network and to transmit a propose response message to a first mobile terminal according to a received response message upon receiving the propose request message including the identification information from the first mobile terminal while managing identification information of each mobile terminal.

2. The system of claim 1, wherein each of the mobile terminals includes:
a first storing unit to store code data based upon classified condition data for condition items of the profile information according to the subscriber's selection;
a second storing unit to store code data based upon classified condition data for condition items of the desired person's information according to the subscriber's selection; and
an association management processing unit to request profile information when another mobile terminal is approached within a range of the short-distance communication network, and to transmit the propose request message to the association management server according to a consistency degree between the condition item of the profile information according to the received code data and the condition item of the desired person's information stored in the second storing unit.

3. The system of claim 2, further comprising a Bluetooth processing unit to transmit the code data using a Bluetooth communication method through the short-distance communication network and to provide the received code data to the association management server.

4. The system of claim 2, wherein the association management processing unit transmits code data according to the profile information stored in the first storing unit or its identification information to another mobile terminal via the short-distance communication network when the another mobile terminal requests the profile information.

5. The system of claim 1, wherein each of the mobile terminals transmits the propose request message including the code data received through the short-distance communication network or the identification information to the association management server via a mobile communication network.

6. The system of claim 1, wherein when the association management server receives code data of the second mobile terminal or the identification information from the first mobile terminal while managing code data based upon the profile information or the desired person's information according to for the subscriber of each mobile terminal, the association management server determines a consistency degree between the desired person's information of the subscriber according to the identification information and the profile information according to the code data of the second mobile terminal and thereafter transmits a propose message including subscriber information of the first mobile terminal and propose request information to the second mobile terminal.

7. The system of claim 6, wherein the subscriber information is phone number information of each mobile terminal or the subscriber's personal information.

8. The system of claim 1, wherein the association management server includes callback URL information in the propose message to allow the second mobile terminal to transmit a response message using the callback URL information.

9. The system of claim 1, wherein the association management server sets a voice communication between mobile terminals or transmits a received association information in a short message form to another mobile terminal when the response message received from the second mobile terminal includes propose acceptance information.

10. The system of claim 1, wherein the association management server transmits propose refusal information to the first mobile terminal when the response message received from the second mobile terminal includes the propose refusal information.

11. The system of claim 1, wherein the identification information is information related to a terminal electronic serial number or information related to a Bluetooth module ID.

12. The system of claim 1, further comprising a recommendation mobile terminal to add recommendation information according to each condition item with respect to profile information of each mobile terminal.

13. The system of claim 1 or 11, wherein each mobile terminal backups the recommendation information added from the recommendation mobile terminal in the association management server, and, for a request of the profile information, simultaneously provides the recommendation information added from the recommendation mobile terminal together with code data according to the profile information.

14. The system of claim 1, wherein the association management server stores at least one or more type-based information among subscriber information of each mobile terminal, code data information of the profile information set in a mobile terminal according to each subscriber, code data information of the desired person's information set in the mobile terminal according to each subscriber, identification information of each mobile terminal according to the propose request message received from each mobile terminal, information related to a consistency degree, propose information according to each subscriber or association information between the subscribers.

15. A mobile communication system comprising:
at least one or more mobile terminals to store code data based upon profile information and desired person's information according to a subscriber's selection, and to transmit an association message to another mobile terminal via a short-distance communication network according to a consistency degree between code data received from the another mobile terminal via the short-distance communication network and the code data of the desired person's information.

16. The system of claim 15, wherein each mobile terminal includes:
a third storing unit to store code data based upon classified condition data for each condition item of the profile information according to the subscriber's selection;
a fourth storing unit to store code data based upon classified condition data for each condition item of the desired person;s information according to the subscriber's selection;
a fifth storing unit to store at least one or more association messages including association information and input code data corresponding to each association message; and
an association processing unit to request profile information when another mobile terminal is approached within a range of the short-distance communication network, to display each association message stored in the fifth storing unit according to a consistency degree between the condition item of the profile information according to the received code data and the condition item of the desired person's information stored in the fourth storing unit, and to transmit input code data corresponding to the association message selected by the subscriber to the another mobile terminal.

17. The system of claim 16, wherein the association processing unit transmits the code data according to the profile information or the input code data to the another mobile terminal using a Bluetooth communication method.

18. The system of claim 15, wherein each mobile terminal stores condition information set by the subscriber, and, after confirming whether the code data received from the another mobile terminal satisfies the stored condition, if the condition is satisfied therewith, each mobile terminal determines consistency information between the desired person's information and the profile information.

19. The system of claim 18, wherein the condition information is one of active/passive condition information to set whether to request profile information through the short-distance communication network, weight value condition information to add a weight value to a condition item of the profile information, search condition information to search for at least one or more condition items according to each type thereof among the condition items, restriction condition information to restrict at least one or more condition items among the condition item or particular condition information to designate at least one or more condition items among each condition item.

20. The system of claim 15, further comprising
a program providing server to provide an association processing program through a wired or wireless network such that each mobile terminal generates code data according to desired person's information, requests profile information from another mobile terminal approaching to the short-distance communication network, and transmits the association message according to a consistency degree between the received profile information and the desired person's information.

21. A service providing method in a mobile communication system comprising:
a step in which at least one or more mobile terminals store code data based upon profile information and desired person's information according to a subscriber's selection;
a step in which a first mobile terminal requests profile information from a second mobile terminal approaching to a short-distance communication network;
a step in which the first mobile terminal transmits a propose request message including identification information to an association management server according to a consistency degree between code data received from the second mobile terminal via the short-distance communication network and the code data of the desired person's information;
a step in which the association management server transmits a propose message to the second mobile terminal via a mobile communication network according to the identification information included in the propose request message; and
a step in which the association management server a propose response message to the first mobile terminal according to a message in response to the propose message.

22. The method of claim 21, wherein the propose message is transmitted as a short message form by the association management server via the mobile communication network.

23. The method of claim 21, further comprising:
a step in which the association management server manages identification information of each mobile terminal;
a step in which the association management server recognizes the second mobile terminal according to the identification information included in the propose request message to transmit the propose message including propose information or callback URL information to the second mobile terminal;
a step in which the second mobile terminal displays the propose information included in the propose message; and
a step in which the second mobile terminal transmits a response message including propose acceptance information or propose refusal information according to the subscriber's selection to the association management server using the callback URL information.

24. The method of claim 21, further comprising:
a step in which the association management server transmits subscriber information of the first mobile terminal to the second mobile terminal to set a voice communication between the mobile terminals when the response message received from the second mobile terminal includes the propose acceptance information; and
a step in which the association management server transmits the propose response message including the propose refusal information to the first mobile terminal when the response message received from the second mobile terminal includes the propose refusal information.

25. The method of claim 21, further comprising:
a step in which the association management server determines a consistency degree between the profile information of the first mobile terminal and the desired person's information of the second mobile terminal upon receiving the propose request message from the first mobile terminal; and
a step in which when the consistency degree is the same as that included in the propose request message, the association management server transmits the propose message to the second mobile terminal.

26. The method of claim 21, wherein the code data of the profile information is transmitted through the short-distance communication network using a Bluetooth communication method.

27. The method of claim 21, wherein the identification information is information related to a terminal electronic serial number or information related to a Bluetooth module ID.

28. The method of claim 21, further comprising:
a step of performing a backup process of recommendation information in the association management server when the recommendation information with respect to the profile information is added from a recommendation mobile terminal of each mobile terminal; and
a step of simultaneously transmitting the code data for the profile information and the recommendation information when there is the request of the profile information.

29. A service providing method in a mobile communication system comprising:
a step in which at least one or more mobile terminals store code data of profile information and desired person's information according to a subscriber's selection;
a step in which a first mobile terminal requests profile information from a second mobile terminal which is connected to a short-distance communication network; and
a step in which the first mobile terminal transmits an association message to the second mobile terminal according to a consistency degree between code data of the received profile information and the code data of the desired person's information.

30. The method of claim 29, further comprising:
a step in which each terminal stores an association message including at least one or more association information and input code data corresponding to each association message; and
a step of transmitting the input code data corresponding to the association message selected by the subscriber through the short-distance communication network.

31. The method of claim 29, further comprising:
a step of storing condition information set by the subscriber;
a step of determining whether the consistency degree between the code data of the received profile information and the code data of the desired person's information satisfies the condition information; and
a step of determining the consistency degree of each code data when the condition information is satisfied therewith.

32. The method of claim 29, further comprising:
a step in which each mobile terminal requests an association managing program from a program providing server;
a step in which each mobile terminal receives the association managing program from the program providing server via a wired or wireless network; and
a step in which each mobile terminal installs the association managing program and generates the code data for profile information or the desired person's information according to a subscriber's selection.
